(19) United States
(12) Patent Application Publication
(10) Pub. No.: US 2016/0132126 A1
(43) Pub. Date: May 12, 2016

(54) SYSTEM FOR INFORMATION TRANSMISSION IN A MOTOR VEHICLE

(71) Applicants: Alexander van Laack, Aachen (DE); Bertrand Stelandre, Thimister (BE); Stephan Preussler, Alfter (DE); Matthias Koch, Montigny Le Bretonneux (FR)

(72) Inventors: Alexander van Laack, Aachen (DE); Bertrand Stelandre, Thimister (BE); Stephan Preussler, Alfter (DE); Matthias Koch, Montigny Le Bretonneux (FR)

(21) Appl. No.: 14/934,942

(22) Filed: Nov. 6, 2015

(30) Foreign Application Priority Data
Nov. 7, 2014 (DE) 10 2014 116 292.7

(51) Int. Cl. G06F 3/01; B60K 35/00; G02B 27/01

(52) U.S. Cl. CPC G06F 3/017; G02B 27/0179; B60K 35/00; G02B 2027/0181

(57) ABSTRACT

A system for information transmission in a motor vehicle and methods of operation are disclosed. A steering wheel, a dashboard with a cover, a dashboard display area with a dashboard display, and a display device arranged in the area of a windshield are provided in a passenger compartment of the motor vehicle. The system is designed for gesture recognition and comprises a gesture recognition unit with at least one gesture recognition sensor. The gesture recognition sensor is configured to detect movements in a perceivable gesture area. The gesture recognition sensor is arranged in the viewing direction of a vehicle driver, behind the steering wheel, under the cover in the dashboard display area. The dashboard display and the display device are designed for the representation of interactive menus.

### CROSS-REFERENCE TO RELATED APPLICATIONS

This application claims priority to German Patent Application No. 10 2014 116 292.7, filed Nov. 7, 2014 and entitled “System for Information Transmission in a Motor Vehicle,” which is herein incorporated by reference.

### BACKGROUND

Various conventional input systems and output systems are used for the control of the functions of a motor vehicle. These conventional input and output systems may include touch-sensitive display units or display units with a touch-sensitive input and/or output device. Additionally, gesture recognition systems can be used for entering information into processing systems of the motor vehicle.

Gesture recognition systems known in the prior art are typically arranged in a central location of the passenger compartment, in particular, in the center console below the dashboard and thus at a distance from the steering wheel. Such an arrangement of the gesture recognition system at a distance from the steering wheel results in the steering wheel not being utilized for the entry of information. Consequently, a driver may not keep his or her hands on the wheel and may also need to avert their gaze from the street, resulting in a distraction and potentially unsafe situation for the vehicle driver and of the occupants of the motor vehicle.

In an effort to remedy these unsafe situations, some input systems include touch sensors arranged within the steering wheel and/or on the surface of the steering wheel. Information is transmitted to the system through contact with the different sensors. However, only a very limited space is available for the arrangement of the sensors on the surface of the steering wheel. The design of the sensors, in addition, can lead to detrimental modifications on the steering wheel as an interaction device. The addition of numerous switches and/or operating knobs to the surface of the steering wheel, the additional electronic elements arranged in the interior, and additional wiring for operating such input systems leads to great complexity in such approaches. These input systems also commonly include display devices which are used only for displaying values such as the speed of the vehicle or warning messages. No provisions are made for direct interaction between the vehicle driver and the display device. Any interaction between the vehicle driver and the display device occurs only via the sensors arranged on the surface of the steering wheel.

Accordingly, there remains a significant need for an improved system for information transmission in a motor vehicle providing for the control of the functions of the motor vehicle as well as for entering information into processing systems of the motor vehicle.

### SUMMARY

This section provides a general summary of the disclosure and is not a comprehensive disclosure of its full scope or all of its features, aspects or objectives.

A system for information transmission in a motor vehicle is disclosed. A dashboard with a cover is provided in a motor vehicle. The system includes a gesture recognition unit with at least one gesture recognition sensor configured to detect movements in a perceivable gesture area. The at least one gesture recognition sensor is arranged under the cover.

A method of highlighting a selected interaction area on a display is provided and begins by performing a gesture by a vehicle driver to be detected by a gesture recognition unit of the system. The method proceeds by detecting the gesture and outputting a gesture signal corresponding to the gesture using a gesture recognition sensor and transmitting the gesture signal to the hardware of the system.

The next step of the method of highlighting a selected interaction area on a display is receiving the gesture signal and determining whether the gesture is recognized using the hardware. If the gesture is not recognized, the next step of the method is sending an error message indicating that the gesture is not recognized to the display. If the gesture is recognized, the next step of the method is identifying the selected interaction area of the display to which the gesture points.

The method of highlighting a selected interaction area on a display continues by verifying whether the area of the display corresponds to a valid interaction area of the display. If the gesture does not point to a valid interaction area, the next step of the method is making the selected interaction area of the display remain un-highlighted. However, if the gesture points to a valid interaction area, the next step of the method is highlighting the selected interaction area of display.

A method of transmitting a gesture signal of the system and performing corresponding selected functions is also provided and begins by performing a gesture by a vehicle driver to be detected by a gesture recognition unit of the system. Next, detecting the gesture and outputting a gesture signal corresponding to the gesture using the gesture recognition sensor and transmitting the gesture signal to the hardware of the system. At the same time, determining a steering wheel position and outputting a steering wheel position signal corresponding to the steering wheel position. Next, evaluating the gesture signal generated by the gesture recognition sensor and received by the system and the steering wheel position signal to determine whether the gesture can be recognized and used for operating the system.

The next step of the method of transmitting the gesture signal of the system and performing corresponding selected functions is sending an error message indicating that the gesture is not recognized to the display in response to the gesture not being recognized.

The method of transmitting the gesture signal of the system and performing corresponding selected functions continues by determining the function of the motor vehicle to be modified based on operating modes and vehicle data. If the gesture is recognized, the next step is comparing the recognized gestures in context based on the operating modes and the vehicle data to determine the selected function of the motor vehicle being modified.

The method of transmitting the gesture-based information of the system and performing corresponding selected functions proceeds by sending an error message to the display indicating that the comparison of the recognized gestures in context is not successful. However, if the context-related comparison of the detected gesture is successful, the method concludes with the step of performing and confirming the performance of the selected function of the motor vehicle.

Thus, the system for information transmission in a motor vehicle and methods of operation according to the disclosure provide various advantages. The steering wheel is one the most contacted elements within the motor vehicle, and the system of the disclosure enables the steering wheel to be an interactive surface or an adaptable input or interaction device without overloading the steering wheel with switches and operating knobs. Additionally, this use of the steering wheel as an input or interaction device can be achieved without integrating additional electronic elements on or within the steering wheel. The information to be transmitted between the vehicle driver and the system is also independent of the number of hands or the number of fingers. Consequently, the dashboard display and a display device arranged in the area of the windshield and other vehicle systems may be easily operated in the motor vehicle.

The gesture recognition sensor of the gesture recognition unit can be integrated into an area of the dashboard display without large additional costs, as well as no additional electronic elements or only a minimal number of them within the steering wheel. As a result, fewer cables or wires need to be utilized and there can be an increase in the efficiency of the system as a flexible and adaptable interaction system for the vehicle driver, and reduction of the complexity of the corresponding operating elements.

The overall interaction of the vehicle driver with the motor vehicle via the dashboard display and the display device arranged in the area of the windshield occurs directly via the electronics embedded in the dashboard to control vehicle systems such as the audio system and the safety systems. This interaction is accomplished even though the input surface itself does not represent part of the electronics embedded in the dashboard. Advantageously, the interaction between the vehicle driver and the motor vehicle can occur while the driver's eyes are on the road, and while the driver's hands remain on the steering wheel. More specifically, gestures performed in the air, close to the steering wheel and the vehicle driver does not have to move his or her hands to the center console. Thus, the system of the disclosure can provide interaction that results in little or no distraction of the vehicle driver and promotes high attentiveness.

Moreover, the arrangement of the sensor to protect it from solar radiation leads to largely undisturbed detecting and registering of the signals and information transmitted (i.e. gesture signals) for the interaction. Therefore, erroneous information and operating errors can be avoided.

Further areas of applicability will become apparent from the description provided herein. The description and specific examples in this summary are intended for purposes of illustration only and are not intended to limit the scope of the present disclosure.

### BRIEF DESCRIPTION OF THE DRAWINGS

The drawings described herein are for illustrative purposes only of selected embodiments and not all implementations, and are not intended to limit the present disclosure to only that actually shown. With this in mind, various features and advantages of example embodiments of the present disclosure will become apparent from the written description when considered in combination with the appended Figures, wherein:

FIG. 1 is a side view of a system for information transmission in a motor vehicle area illustrating the passenger compartment of a motor vehicle in the viewing direction of a vehicle driver, in front of the vehicle driver;

FIG. 2 is a front view of the system for information transmission of FIG. 1;

FIG. 3 is a perspective view of the system for information transmission of FIG. 1;

FIG. 4 illustrates an example of a controller for managing the system of FIGS. 1-3;

FIG. 5 is a flow diagram illustrating the steps of operating a system for information transmission including highlighting a selected interaction area on a display; and

FIG. 6 is a flow diagram illustrating the steps of operating a system for information transmission including transmitting a gesture signal of the system and performing corresponding selected functions.

### DETAILED DESCRIPTION

Systems for the entry of vehicle driver information into an operating system of a motor vehicle conventionally transmit information via movements of a finger of a vehicle driver's hand. Such systems include a sensor for detecting the movements of the fingers and gestures. Such systems also include a processor for evaluating the movements and a display device arranged in the field of vision of the vehicle driver. The information detected by the sensor (e.g., the movements of the finger of the vehicle driver) is evaluated by the processor and can be displayed in the display device. The display device can be a “heads up display” (HUD) and arranged in the area of the windshield of the motor vehicle. A HUD is a display system in which the user can maintain the position of their head and their viewing direction in the original orientation (e.g., looking forward through the windshield of the vehicle) when viewing the displayed information, since the information is projected into the field of vision. In general, HUDs comprise an imaging unit which generates an image, an optics module, and a projection surface. The optics module directs the image onto the projection surface, which is designed as a reflective, light-permeable panel. The vehicle driver sees the reflected information of the imaging unit and at the same time the actual environment behind the panel. For starting and ending the information transmission, switch elements such as switches or operating knobs can be operated.

In addition, the sensor of such a system may be arranged on the surface of the dashboard and thus, depending on the direction of the incident sunrays, can be exposed to direct solar radiation. This direct solar radiation can lead to errors in the recognition of the finger gestures by the sensor. Additionally the system may be configured to register the movements of a finger of only one hand, in particular the right hand, the finger being pointed at the display device arranged in the area of the windshield. So, the input and the output of the information occur only via the display device arranged in the area of the windshield.

In certain other applications, a system for the entry of information into an operating system of a motor vehicle may comprise a display device embedded within the dashboard and at least one sensor for detecting a movement of an index finger and for detecting an area of the display device to which the index finger of a vehicle driver's hand points. The location pointed to by the index finger of the vehicle driver's hand is represented within the display device by means of a location indicator (i.e., a cursor). In reaction to the movement of the finger, a function of the system may be performed.

In general, starting and ending the information transmission in prior art systems for the entry of information typically entail the use of switch elements such as switches and/or operating knobs. In addition, the systems are not designed for registering movements on or along the surface of the steering wheel. Moreover, the movements that can be registered are performed only by one hand.

Disclosed herein is a system for information transmission in a motor vehicle and methods of operation that provide interactive operation by the vehicle driver with a dashboard display and a display device arranged in the area of the windshield. Specifically, by detecting movement the vehicle driver's hand and/or finger in the area of the steering wheel, a function of the motor vehicle can be operated or modified. The interaction between the vehicle driver and the system is made possible without any additional sensors formed in or on the steering wheel, or other electronic elements within the vehicle. The recognition and registering of the signals and information transmitted take place largely without interference in order to avoid erroneous information and thus operating errors of the system. Consequently, it is possible to transmit information independently of the number of hands or the number of fingers.

The system for information transmission for a motor vehicle that is disclosed enables interactive operation by the vehicle driver and includes a dashboard display and a display device (e.g., heads up display) arranged in the area of the windshield. The system is designed for gesture recognition and comprises a gesture recognition unit with at least one gesture recognition sensor. The gesture recognition sensor is configured to detect movements in a perceivable gesture area. With the system, functions of the motor vehicle are controlled, such as the air conditioning system, the infotainment system, for example, the audio system, and the like.

The disclosure moreover relates to a method for operating the system in order to highlight a selected interaction area on a display as well as to a method for operating the system for transmitting a gesture signal and performing corresponding selected functions

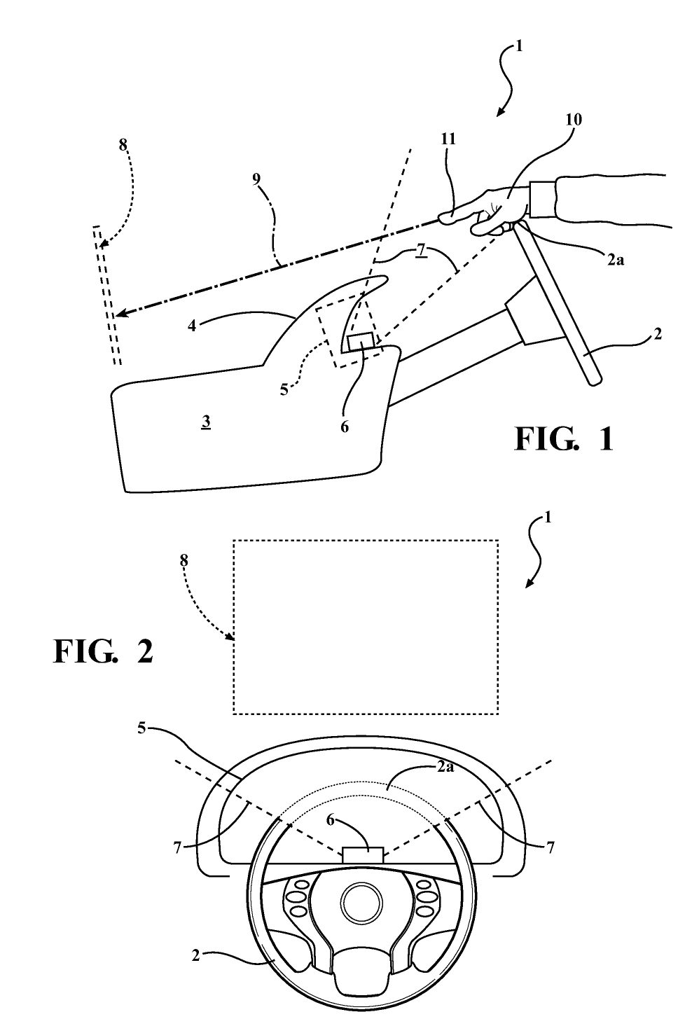

FIG. 1 illustrates a gesture-based system 1 for information transmission for a motor vehicle. The system 1 is shown in an area of the passenger compartment of the motor vehicle in front of and in the viewing direction of a vehicle driver. The system 1 is used for detecting gestures made by the driver. The system 1 is arranged within an area behind the steering wheel 2 of the motor vehicle. More specifically, the area is delimited by the windshield and a dashboard 3 (i.e., instrument panel) with a cover 4. The dashboard 3 also includes a dashboard display area 5.

Within the dashboard 3, a gesture recognition unit 6 is disposed. The gesture recognition unit 6 includes at least one gesture recognition sensor. The gesture recognition sensor is thus placed in the viewing direction of the vehicle driver, behind the steering wheel 2 in the dashboard display area 5. Such an arrangement allows the gesture recognition sensor to detect gestures and movements of the vehicle driver within a perceivable gesture area 7 and to receive them as information or signals in the gesture recognition unit 6. This gesture information is subsequently processed within the gesture recognition unit 6. The gesture recognition sensor arranged under the cover 4 is preferably designed as a component of the dashboard display and may not represent a separate module. Because the gesture recognition sensor is located within the dashboard display under the cover 4, it is advantageously protected from direct solar radiation, which allows an undisturbed reception of the gesture information. This reception of gesture information allows for the interaction of the vehicle driver with the system 1 through gestures.

The gesture recognition unit 6 generates an image and it is configured to detect gestures which are performed either on the steering wheel 2, in an area between the steering wheel 2 and the dashboard 3, or in the area of the center console of the motor vehicle.

The at least one gesture recognition sensor is advantageously arranged in a plane parallel to a plane defined by the steering wheel 2, in the viewing direction of the vehicle driver, at the height of the dashboard display area 5, and, in the horizontal direction, in the center of the dashboard display area 5. Therefore, the at least one gesture recognition sensor allows the detection, reception and differentiation of the gestures and movements of the two hands of the vehicle driver. Alternatively, two or more gesture recognition sensors can also be arranged in order to detect, receive and differentiate the gestures and movements of the vehicle driver's hands. In the case of two or more gesture recognition sensors, the sensors may be distributed within the dashboard display area 5, in order to optimally cover the perceivable gesture area 7.

In one example system 1, the gesture recognition sensor of the gesture recognition unit 6 is positioned to receive the movement of a hand 10 or of both hands 10 of the vehicle driver, in particular, the movement of a finger 11 (especially an index finger), for the control of functions of the motor vehicle. The hand 10 and the finger 11 are moved as best shown in FIG. 1 on the steering wheel 2, or adjacent to an upper edge of the steering wheel 2 in the area 2a and point in the viewing direction of the vehicle driver.

The gesture recognition unit 6 or hand motion detection unit, for example, may comprise sensors for receiving smooth as well as jumpy movements. The gesture recognition sensors here may include sensors such as, but not limited to ultrasound sensors, infrared sensors or the like, or as a time-of-flight (TOF) camera or for the use of structured light, which generate an image, particularly a 3D image. Specifically, the gesture recognition sensor could include sensors such as, but not limited to sensors manufactured by Leap Motion®, SoftKinetic®, or any other kind of camera, or sensor that can provide a depth map.

A TOF camera is a 3D camera system which measures distances using the time-of-flight method. Here, the gesture perceivable area 7 can be illuminated with a light pulse. For each image point, the camera measures the time needed for the light to travel to the object (e.g., finger 11) and back again. The time needed is directly proportional to the distance, so that the camera determines for each image point the distance of the object imaged on it.

In the case of the gesture recognition sensor operating with structured light, a certain pattern is transmitted in the visible or in the invisible range. The pattern curves in accordance with 3D structures in space (e.g., finger 11). The curvature is received and compared to an ideal image. From the difference between the ideal image and the real image determined by means of the curvatures, the position of an object in space can be determined.

In addition to the dashboard display arranged in the dashboard display area 5, the system 1 also includes a display device 8 arranged in the area of the windshield and designed particularly as a heads up display. Both the dashboard display and also the display device 8 are used for displaying interactive menus and elements. Therefore, the interactive operation of the system by the vehicle driver can occur both using the dashboard display and the display device 8 arranged in the area of the windshield, individually or in combination.

The interaction between the vehicle driver and the dashboard display and/or the display device 8 can be started while the surface of the hand 10 is in contact with the steering wheel 2. The interaction starts here, for example, with a movement of the vehicle driver's finger 11 in the direction of the dashboard 3 (i.e., in the direction of the dashboard display and/or the display device 8). The interactions between the vehicle driver and the dashboard display and/or the display device 8 are shown in the menu of the dashboard display and/or the display device 8 as soon as at least one finger 11 points to one of the two displays. The gesture recognition unit 6 is thus started or stopped without actuation of a switch. However, it should be appreciated that the gesture recognition unit 6 and the interaction can also be started by the actuation of an additional component (e.g., switch) or by contacting the steering wheel 2.

After the start of the interaction, the user interface of the dashboard display and/or of the display device 8 is controlled by gestures of hands 10 and/or fingers 11. An image can be generated by the gesture recognition unit 6, in which the finger 11 is arranged, or the motion detection hardware integrated in the gesture recognition unit 6 can detect the finger 11 of the hand 10 by depth recording of the gestures. Specifically, the position of a tip of the finger 11 can be detected, in the three-dimensional space, taking into consideration the angle of the finger 11 in space for the conversion of the position of the tip of the finger 11 and angle into a reference to at least one of the displays. Depending on the movement of the finger 11, a vector 9 is created. The vector 9 includes the direction and angle in which the finger 11 points.

This vector 9 or vector space function of the gesture subsequently allows further calculations by the gesture recognition unit 6. Due to a movement of the finger 11 to another location (i.e., a target object on the dashboard display or on the display device 8), the vector 9 of the finger 11 changes. Afterward, the new location of the finger 11 is calculated and associated with a target object on the dashboard display or on the display device 8.

Interactive menus are represented on the dashboard display and/or on the display device 8 which are adapted as soon as a finger 11 points to them. The user interface shown on the dashboard display and/or on the display device 8 is controlled by an individual gesture 11 of the finger, the gesture of a group of fingers 11, or the gesture of a hand 10 or of both hands 10. As a result, interaction by the vehicle driver with the dashboard display and/or the display device 8 through the movement is used for the menu selection. Through the gestures and the directed movements relative to the user interface of the dashboard display and/or of the display device 8 and corresponding changes to the displays, selected functions of the motor vehicle are performed and controlled. These functions can include, but are not limited to the air conditioning system, the infotainment system, the driver assistance system or the like. The movements and gestures of finger 11 and/or hand 10 occur in free space or on surfaces, for example, on the steering wheel 2, and they produce a change or an adjustment of different functions in the motor vehicle.

For three-dimensional gesture recognition, the gesture recognition unit 6 is configured to detect the size or the shape of hands 10 and/or fingers 11 and associate them with a certain user profile stored in the system 1 (i.e., a certain person). Therefore, at the time of contacting the steering wheel 2, the system 1 can detect which person is driving the motor vehicle since an individual user profile is set up in the system 1 for each registered person. Here, the user profile contains the values for presettings of different functions in the motor vehicle, such as of the air conditioning system or the audio system, among other information.

The recognition of the person based on the hand 10 and/or the finger 11 is limited to the group of persons stored in the system 1 (i.e., those with user profiles). With the recognition of the person who is driving the motor vehicle, the settings of certain functions in the vehicle can be adapted.

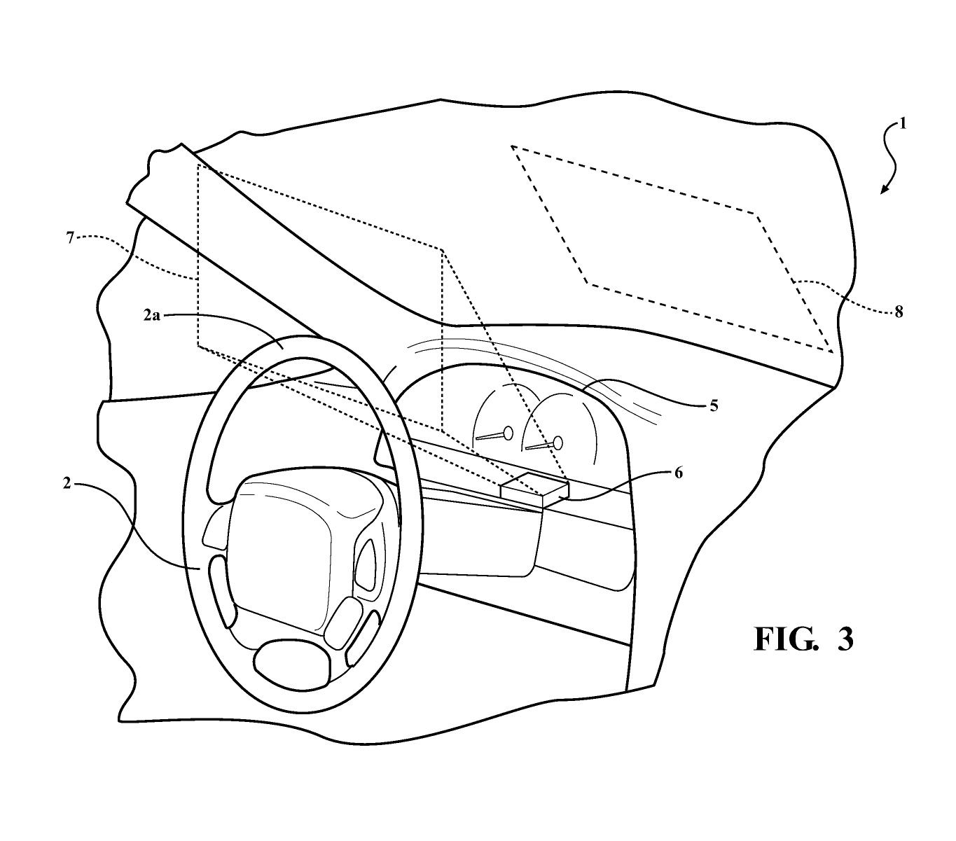

FIG. 2 shows the system 1 from the perspective of the vehicle driver in the passenger compartment. FIG. 3 shows a perspective view of the system 1. The gesture recognition sensor of the gesture recognition unit 6 is arranged and configured so that the perceivable gesture area 7 substantially allows the interaction in the upper area 2a of the steering wheel 2, particularly at the upper edge of the steering wheel 2. The perceivable gesture area 7 extends preferably over an angular range of 120°, wherein the limits of the angular range are each oriented at a 60° deviation from the vertical direction. In other words, comparing the round steering wheel 2 to a clock face of an analog clock, the gestures of the hand 10 or of the fingers 11 are detected substantially in an area between 10 o'clock and 2 o'clock. Both gestures corresponding with a surface interaction on the steering wheel 2 and also in the vicinity of the steering wheel 2 are detected, especially between the steering wheel 2 and the cover 4 of the dashboard display area 5. The perceivable gesture area 7 can also include the area located in front of the center console of the motor vehicle.

The detectable gestures include, for example, tapping gestures or tapping movements, hitting movements, stroking movement, pointing gestures or the like. Tapping movements or hitting movements on the steering wheel 2 as well as stroking movements of the hands over the steering wheel 2 are recognized, received and converted into commands or orders. The movements and gestures can, in addition, be recorded by the system 1.

Referring specifically to gestures corresponding with a surface interaction on the steering wheel 2, movements, particularly stroking or flipping movements with the hand 10 along the upper edge of the steering wheel 2 result in scrolling, browsing, switching or moving in areas through or between menus or in changing functions, for example. For instance, if the system detects a hand forming a first or flat hand 10 on the upper edge of the steering wheel 2 and the hand is moved in the upper area 2a, the movement can be used for setting the scale or the magnitude such as the loudness of the audio system, the air temperature of the air conditioning system, or the light intensity of the displays or inside the vehicle. In should be noted that the areas which are selected and which functions are modified can depend additionally on which hand 10 (right or left) is making the gestures or movements.

In order to differentiate the movement of the hand 10 on the upper edge of the steering wheel 2 from a movement of the steering wheel 2 itself, the angle of the position of the steering wheel 2 and the change in angle of the steering wheel 2 are included in the calculation algorithm. In the case of a constant position of the steering wheel 2 or a change in the position of the angle of the steering wheel 2 of approximately 0° (i.e., the steering wheel is not being rotated), the movement of the hand 10 is detected as stroking over the upper edge of the steering wheel 2, which leads to a change and operation of the extent of the selected function. When the change in the position of the angle of the steering wheel deviates clearly from 0°, the movement of the hand 10 is considered a steering maneuver, in which case the selected functions remain unchanged.

Now referring specifically to gestures in the vicinity of the steering wheel 2, the interaction between the vehicle driver and the dashboard display and/or the display device 8 may be started for example, by contacting the steering wheel 2 with both hands 10 in the area between 10 o'clock and 2 o'clock and by moving or raising a finger 11 (e.g., the index finger). The system 1 recognizes this standard gesture, and the input interface of the gesture recognition unit 6 is activated, while the surface of the hand 10 is in contact with the steering wheel 2.

When pointing at the dashboard display and/or display device 8, an area of the respective display is highlighted by stronger illumination than the surroundings of the area. The stronger illumination notified that the area is selected. It should be understood that the selected area may be highlighted by other ways such as a different color, shading, animations, or blinking.

As another example of operation, a hitting movement with the index finger of the left hand 10 can switch the audio system of the motor vehicle off, while a stroking movement of the left hand 10 leads to a change of the loudness or volume of the audio system. Different stroking movements of the right hand 10 in turn produce a change in the display within the display unit 8 or the dashboard display.

The movement of a finger 11 of a hand 10 onto an element of the display device 8 or of the dashboard display selects the element. Tapping the finger 11 on the upper edge of the steering wheel 2 can perform the function associated with the selected element.

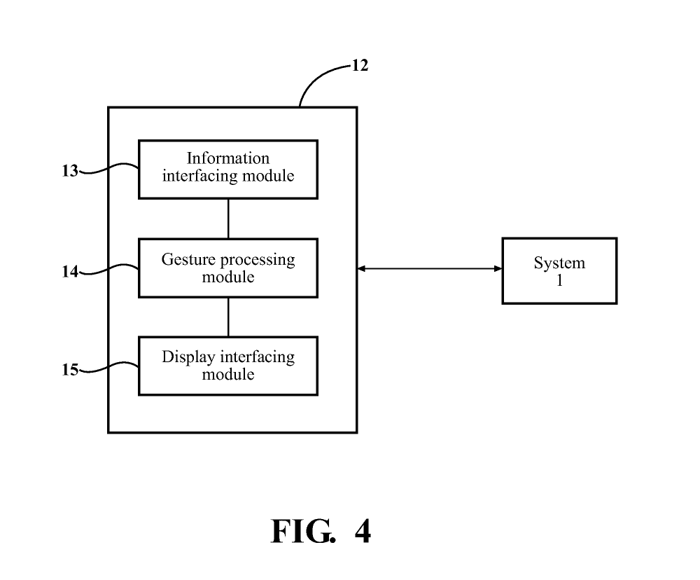

FIG. 4 illustrates an example of a controller 12 for managing the system 1. The controller 12 may be implemented as part of the hardware of system 1 (e.g., as part of gesture recognition unit 6) or could be implemented as a separate control unit, for example. The controller 12 can include, for instance, an information interfacing module 13, gesture processing module 14, and a display interfacing module 15. As used herein, the term “module” refers to computer program logic used to provide the specified functionality. Thus, a module can be implemented in hardware, firmware, and/or software. For example, the information interfacing module 13, gesture processing module 14, and display interfacing module 15 could be stored and executed by the hardware of system 1 (e.g., as part of gesture recognition unit 6).

The information interfacing module 13 interfaces with the vehicle systems of motor vehicle (e.g., air conditioning system, the infotainment system, etc.). The information sourced from the information interfacing module 13 may be provided via digital or analog signals communicated with the plurality of vehicle systems. The frequency of how often the systems are monitored may be determined by an implementation of the controller 12.

The gesture processing module 14 communicates with the at least one gesture recognition sensor to process gestures detected by the at least one gesture recognition sensor. As discussed above, the gesture recognition sensor detects gestures and movements of the vehicle driver within the perceivable gesture area 7. The sensor outputs a gesture signal which is received in the gesture recognition unit 6. So, once the gesture recognition unit 6 receives the gesture signal or gesture information, it can manipulated and evaluated using the gesture processing module 14 to carry out the calculation algorithm and to determine the appropriate actions to take. The gesture processing module 14 can also receive the steering wheel position signal in order to take the change in angle of the steering wheel 2 into account when processing gesture signals, for example.

The display driving module 15 serves to drive the dashboard display and/or the display device 8 with appropriate signals based on information from the vehicle systems and based on input from the gesture recognition sensor. The display driving module 14 may be any sort of control circuitry employed to selectively alter the dashboard display and/or the display device 8 of the system 1. The display driving module 15 could also simply instruct other vehicle systems when the dashboard display and/or display device 8 should be updated.

The system 1 can be operated with a method implemented on the controller 12 or processor, for example, to preset and adapt different functions of the motor vehicle. Using the gesture recognition unit 6, a size and/or a shape of at least one hand and/or of at least one finger is/are detected. Subsequently, the detected size and/or shape is/are compared with values stored within the system 1 and associated with a user profile of a person which is stored in the system. An individual user profile can be stored in system 1 for each registered person. When the steering wheel is contacted, which person is driving the motor vehicle can be determined. Since the user profile contains values for presettings of different functions in the motor vehicle, such as the air conditioning system or the audio system, after the identification of the person or of the particular user profile, the settings of the functions are adapted to the presettings.

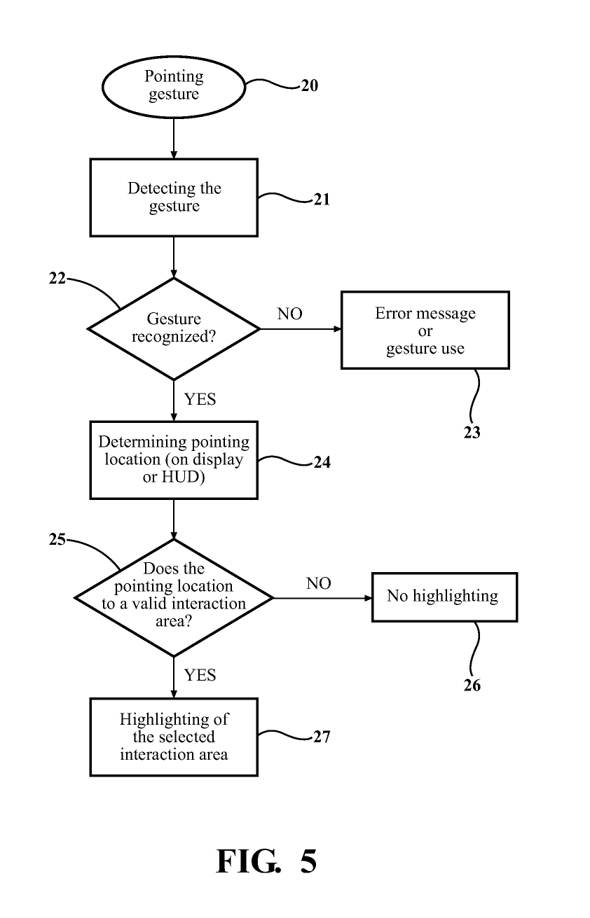

FIG. 5 illustrates a flow chart for the method of highlighting a selected interaction area on a display wherein the display may be the dashboard display and/or the display device 8, for example. The method illustrated by FIG. 5 relates to gestures in the vicinity of the steering wheel 2.

The method of highlighting a selected interaction area on a display begins by 20 performing a gesture by a vehicle driver to be detected by a gesture recognition unit 6 of a system 1. The method proceeds by, 21 detecting the gesture and outputting a gesture signal corresponding to the gesture using a gesture recognition sensor and transmitting the gesture signal to the hardware of the system 1.

The next step of the method of highlighting a selected interaction area on a display is 22 receiving the gesture signal and determining whether the gesture is recognized using the hardware. If the gesture is not recognized, the next step of the method is, 23 sending an error message indicating that the gesture is not recognized to the display in response to the gesture not being recognized. The display may comprise the dashboard display and/or the display device 8, however, it should be understood that the display may include other additional displays or fewer displays. If the gesture is recognized, the next step of the method is, 24 identifying the selected interaction area of the display (e.g., dashboard display and/or of the display device 8) to which the gesture points in response to the gesture being recognized.

The method of highlighting a selected interaction area on a display continues by, 25 verifying whether the area of the display (e.g., dashboard display and/or of the display device 8) corresponds to a valid interaction area of the display. If the gesture does not point to a valid interaction area, the next step of the method is 26 making the selected interaction area of the display remain un-highlighted in response to the gesture not pointing to a valid interaction area. However, if the gesture points to a valid interaction area, the next step of the method is, 27 highlighting the selected interaction area of display in response to the gesture pointing to a valid interaction area. Such highlighting can include, but is not limited to using stronger illumination than the surroundings of the area being highlighted.

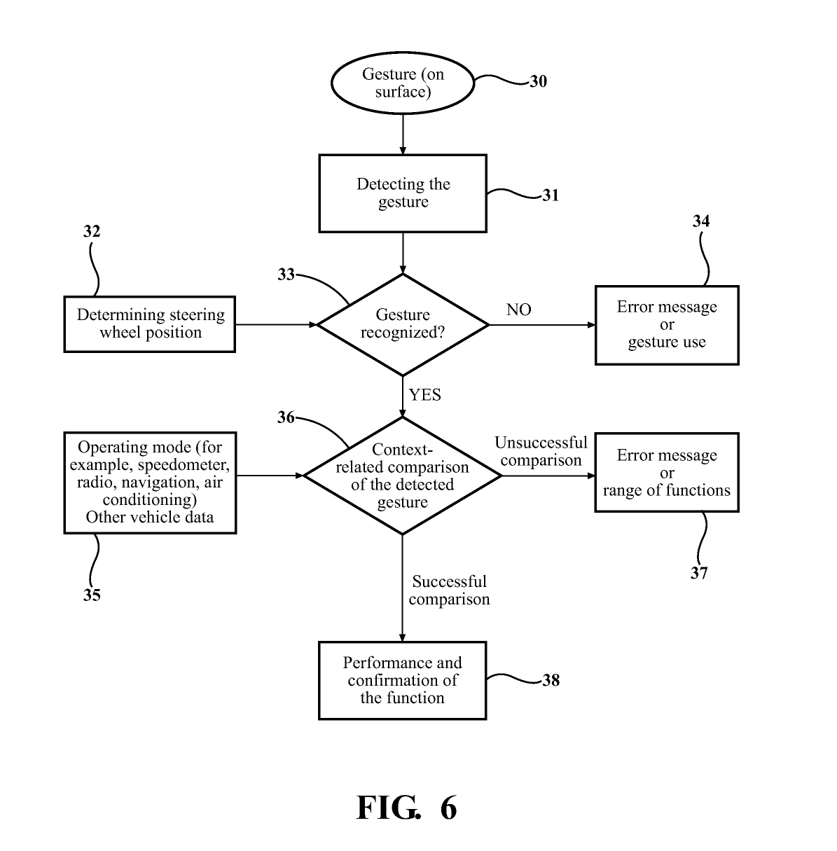

FIG. 6 shows a flow diagram for the method of transmitting the gesture-based information of the system 1 and performing corresponding functions. The method illustrated by FIG. 6 relates to gestures corresponding with a surface interaction on the steering wheel 2.

The method of transmitting a gesture signal (i.e., gesture-based information) of the system 1 and performing corresponding selected functions begins by, 30 performing a gesture by a vehicle driver to be detected by a gesture recognition unit 6 of the system 1. Next, 31 detecting the gesture and outputting a gesture signal corresponding to the gesture using the gesture recognition sensor and transmitting the gesture signal to the hardware of the system 1. At the same time, 32 determining a steering wheel position and outputting a steering wheel position signal corresponding to the steering wheel position (i.e., the angle of the steering wheel 2). Next, 33 evaluating the gesture signal generated by the gesture recognition sensor and received by the system 1 and the steering wheel position signal to determine whether the gesture can be recognized and used for operating the system 1. Such an evaluation could be carried out in the gesture processing module 14 of controller 12, for example.

The next step of the method of transmitting the gesture signal of the system 1 and performing corresponding selected functions is 34 sending an error message indicating that the gesture is not recognized to the display (e.g., dashboard display and/or the display device 8) in response to the gesture not being recognized. The error message indicating that the gesture is not recognized and/or the function cannot be performed can include a message or warning notice of any type.

The method of transmitting the gesture signal of the system 1 and performing corresponding selected functions continues by 35 determining the function of the motor vehicle to be modified based on operating modes and vehicle data. If the gesture is recognized, the next step of the method is 36 comparing the recognized gestures in context based on the operating modes and the vehicle data to determine the selected function of the motor vehicle being modified (e.g., switched). In other words, the comparison is context-related with regard to the function of the motor vehicle to be set.

The method of transmitting the gesture signal or gesture-based information of the system 1 and performing corresponding selected functions proceeds by 37 sending an error message to the display (e.g., dashboard display and/or the display device 8) indicating that the comparison of the recognized gestures in context is not successful in response to the comparison of the recognized gestures in context not being successful. Specifically, if no context-related comparison of the detected gesture can occur, then, an error message regarding the range of functions is sent to the dashboard display and/or the display device 8. However, if the context-related comparison of the detected gesture is successful, the method concludes with the step of 38 performing and confirming the performance of the selected function of the motor vehicle in response to the comparison of the recognized gestures in context being successful. The functions being performed can include, for example, the switching or flipping between media contents of the dashboard display and/or the display device 8.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptions used herein interpreted accordingly.

What is claimed is:

1. A system for information transmission in a motor vehicle having a dashboard with a cover, the system comprising:
a gesture recognition unit including at least one gesture recognition sensor configured to detect movements in a perceivable gesture area; and
the at least one gesture recognition sensor being arranged under the cover.

2. A system as set forth in claim 1 wherein the motor vehicle further includes a steering wheel and wherein the at least one gesture recognition sensor is arranged behind the steering wheel.

3. A system as set forth in claim 2 wherein the gesture recognition unit is configured to generate an image and to detect gestures that are performed in the perceivable gesture area and the perceivable gesture area extends around the steering wheel as well as between the steering wheel and the dashboard.

4. A system as set forth in claim 3 wherein the perceivable gesture area in which gestures are detected extends in an upper area of the steering wheel including the upper edge of the steering wheel and wherein the perceivable gesture area extends over an angular range of 120° and the limits of the angular range are each oriented at a 60° deviation from the vertical direction.

5. A system as set forth in claim 3 wherein the gesture recognition unit is configured to distinguish a gesture in an upper area of the steering wheel from a movement of the steering wheel wherein an angle of the position of the steering wheel and a change in the angle of the position of the steering wheel are included in a calculation algorithm.

6. A system as set forth in claim 2 wherein the motor vehicle further includes a dashboard display area and the at least one gesture recognition sensor is arranged in a plane parallel to a plane defined by the steering wheel in the viewing direction of the vehicle driver at the height of the dashboard display area and in the horizontal direction in the center of the dashboard display area.

7. A system as set forth in claim 1 wherein the motor vehicle further includes a dashboard display area with a dashboard display and a display device arranged in the area of a windshield of the motor vehicle and wherein the at least one gesture recognition sensor is arranged in the dashboard display area and the dashboard display and the display device are configured to display interactive menus.

8. A system as set forth in claim 7 wherein the display device is a heads up display.

9. A system as set forth in claim 7 wherein the gesture recognition unit is configured to be activated by a movement of the vehicle driver in the direction of the dashboard display or the display device and wherein the interactions between the vehicle driver and the gesture recognition unit are displayed in at least one of the menu of the dashboard display and the menu of the display device.

10. A system as set forth in claim 7 wherein the gesture recognition unit comprises motion detection hardware designed for depth recording of the gestures and generating a vector with a direction and an angle in which the gesture occurs, in order to determine a location to which the gesture points, and in order to represent the location in one of the dashboard display and the display device.

11. A system as set forth in claim 1 wherein the gesture recognition unit is configured to detect at least one of a size and shape of at least one hand and at least one finger to compare the detected size and shape with the values stored in the system and to associate the detected size and shape with a user profile of a person that is stored in the system and wherein the user profile comprises presettings of different functions and the functions can be adapted to the presettings.

12. A method for highlighting a selected interaction area on a display, the method comprising the steps of:
performing a gesture by a vehicle driver to be detected by a gesture recognition unit of a system,
detecting the gesture and outputting a gesture signal corresponding to the gesture using a gesture recognition sensor and transmitting of the gesture signal to hardware of the system,
receiving the gesture signal and determining whether the gesture is recognized using the hardware,
sending an error message indicating that the gesture is not recognized to the display in response to the gesture not being recognized,
identifying the selected interaction area of the display to which the gesture points in response to the gesture being recognized,
verifying whether the selected interaction area of the display corresponds to a valid interaction area of the displays,
making the selected interaction area of the display remain un-highlighted in response to the gesture not pointing to a valid interaction area, and
highlighting the selected interaction area of display in response to the gesture pointing to a valid interaction area.

13. A method for transmitting a gesture signal of a system and performing corresponding selected functions, the method comprising the steps of:
performing a gesture by a vehicle driver to be detected by a gesture recognition unit of a system,
detecting the gesture and outputting the gesture signal corresponding to the gesture using the gesture recognition sensor and transmitting the gesture signal to hardware of the system,
determining a steering wheel position and outputting a steering wheel position signal corresponding to the steering wheel position,
evaluating of the gesture signal generated by the gesture recognition sensor and received by the system and the steering wheel position signal to determine whether the gesture can be recognized,
sending an error message indicating that the gesture is not recognized to the display in response to the gesture not being recognized,
determining the function of the vehicle to be modified based on operating modes and vehicle data,
comparing the recognized gestures in context based on the operating modes and the vehicle data to determine the selected function of the vehicle being modified,
sending an error message to the display indicating that the comparison of the recognized gestures in context is not successful in response to the comparison of the recognized gestures in context not being successful,
performing and confirming performance of the selected function of the vehicle in response to the comparison of the recognized gestures in context being successful.
